(19) United States
(12) Patent Application Publication
(10) Pub. No.: US 2003/0165644 A1
(43) Pub. Date: Sep. 4, 2003

(54) Snap-in sheet protector and method of use thereof

(75) Inventors: Donn Meade, Chicopee, MA (US); Bernard M. Poirier, Holyoke, MA (US)

Correspondence Address: OPPENHEIMER WOLFF & DONNELLY LLP, 840 NEWPORT CENTER DRIVE, SUITE 700, NEWPORT BEACH, CA, 92660, US

(73) Assignee: AVERY DENNISON CORPORATION

(21) Appl. No.: 10/346,878

(22) Filed: Jan. 17, 2003

Related U.S. Application Data
(60) Provisional application No. 60/351,047, filed on Jan. 22, 2002.

(51) Int. Cl. B32B 3/10

(52) U.S. Cl. 428/34.1; 428/136; 428/99; 428/192

(57) ABSTRACT

A snap-in sheet protector that may be reversibly inserted into and removed from a binder without opening the binder rings. The snap-in sheet includes a plurality of holes on at least one edge of the snap-in sheet protector. The snap-in sheet protector also includes a plurality of channels that join the edge of the sheet protector to the holes. The region around the holes and channels of the snap-in sheet protector are strengthened by a stiffening member. The stiffening member provides the snap-in sheet protector with sufficient rigidity to allow the sheet protector to be inserted into the binder without opening the binder rings. Furthermore, inserting the snap-in sheet protector is facilitated by a channel having a wider entry point.

### RELATED APPLICATIONS

This application claims benefit to U.S. Provisional Patent Application Serial No. 60/351,047, filed Jan. 22, 2002, all of which is incorporated herein by reference.

### BACKGROUND OF THE INVENTION

Papers and other media have been stored in portfolios, folders, binders, wire-bound notebooks, and the like. Binders are a popular choice of storing media due to their ease of use, storage flexibility, and cost effectiveness. Binders are also desirable because papers or other media may be easily inserted and removed from the binders. Furthermore, binders are useful because the stored media may be easily reorganized. However, stored media such as papers may become worn when constantly referenced. Moreover, the hole punches in the papers may also become worn and may tear with repeated use. As a result, these papers are not securely retained in the binder.

A solution to these problems has been the use of sheet protectors. Sheet protectors are made from one or more flexible sheets that are adapted to form a pocket. The flexible sheets are traditionally made from plastics such as polypropylene. The plastic material is more durable than paper, and the plastic protects the papers or other media inserted into the sheet protector. Thus, frequently used documents will not be damaged with continued use. Furthermore, given the robust physical characteristics of plastic, the hole punches are less likely to become worn or torn. Additionally, sheet protectors are desirable because the materials stored in the sheet protectors may be easily replaced.

While sheet protectors are useful for protecting stored media and securing the media within a binder, inserting the sheet protector into a binder can be time consuming and awkward. The user first opens the binder rings, inserts the sheet protectors, and subsequently closes the binder rings. All of these steps take time, and papers already in the binder can slip off of the rings during the process, causing further inconvenience to the consumer.

Accordingly, sheet protectors having straight slits that extend from hole punches to the edge of the sheet material have been developed. The slits facilitate the insertion and removal of the sheet material without necessitating the opening and closing of the binder rings. The positioning of the slits is important, as they must be properly oriented and positioned. Otherwise, the sheet protector may not be securely retained in the binder. Furthermore, the portion of the sheet protector having the slits and hole punches must have sufficient rigidity to allow the sheet protector to be affixed to the binder rings. That is, the edge of the sheet protector must be sufficiently reinforced to allow the sheet protector to be “snapped” into the binder without opening the binder rings.

In traditional sheet protectors, stiffening members made of various plastics are inserted into a channel along the side of the sheet protector in which the holes are punched. The stiffening members are held in place by friction as the stiffener has the same width as the channel. Since the channels are held in place by friction, the stiffener may become misaligned with the holes and the slits. As a result, it is difficult to insert the sheet protectors into the binder.

Accordingly, it is an object of the present invention to provide a snap-in sheet protector that facilitates the insertion process.

Another object of the present invention is to provide snap-in sheet protector that securely retains the sheet protector in a binder.

It is yet another object of some embodiments of the present invention to provide a snap-in sheet protector having a functional stiffening member.

### BRIEF SUMMARY OF THE INVENTION

The present invention relates to a snap-in sheet protector and methods of making the same. More specifically, the snap-in protector of the present invention may be reversibly inserted and removed without opening the binder rings. The snap-in sheet protector includes a plurality of holes on at least one edge of the snap-in sheet protector. The snap-in sheet protector also includes a plurality of channels that join the edge of the sheet protector to the holes.

The region around holes and channels of the snap-in sheet protector are strengthened by a stiffening member. The stiffening member provides the snap-in sheet protector with sufficient rigidity to allow the sheet protector to be inserted into the binder without opening the binder rings. Furthermore, in some embodiments inserting the snap-in sheet protector is facilitated by a channel having a wider entry point.

One embodiment of the invention relates to a snap-in sheet protector made of at least one flexible sheet of material. The pocket includes a plurality of holes located on one edge of the sheet protector. The pocket also includes a plurality of curved slits that join the edge of the pocket to the holes. The curved slits are adapted for releasable engagement with the rings of loose-leaf ring binders.

In another embodiment of the present invention, the snap in sheet protector has a pocket into which a sheet may be inserted. The sheet protector has a plurality of holes located on one edge, a plurality of curved slits that join the edge of the pocket to the holes, and a stiffening member attached to the edge of the pocket having the holes and curved slits. The stiffening member is permanently attached to the sheet protector and provides the snap-in sheet protector with sufficient rigidity to allow the sheet protector to be inserted into the binder without opening the binder rings.

Additional objects and advantages of the present invention will become readily apparent to those skilled in the art from the following detailed description, wherein only the preferred embodiments are shown and described, simply by way of illustration of the best mode contemplated of carrying out the invention. The present invention can be modified in various respects, all without departing from the scope and spirit of the present invention. Accordingly, the drawings and description are illustrative and not intended to be a limitation thereof.

### BRIEF DESCRIPTION OF THE DRAWINGS

FIG. 1 is a front plan view of the snap-in sheet protector made in accordance with the teachings of the present invention;

FIG. 2 is a perspective view of the snap-in sheet protector of FIG. 1;

FIG. 3 is an enlarged end view of the snap-in sheet protector of FIG. 1 taken along line A-A′;

FIG. 4 is an front plan view of an alternate embodiment of the present invention;

FIG. 5 is a perspective view of yet an alternate embodiment of the present invention;

FIG. 6 is an enlarged view of the hole and channel of the snap-in sheet protector of the present invention; and

FIG. 7 is a perspective view of another embodiment of the present invention.

### DETAILED DESCRIPTION OF THE INVENTION

The present invention discloses a snap-in sheet protector and methods for their production. In accordance with the teachings of the present invention, the snap-in sheet protectors may be reversibly inserted and removed without opening the binder rings.

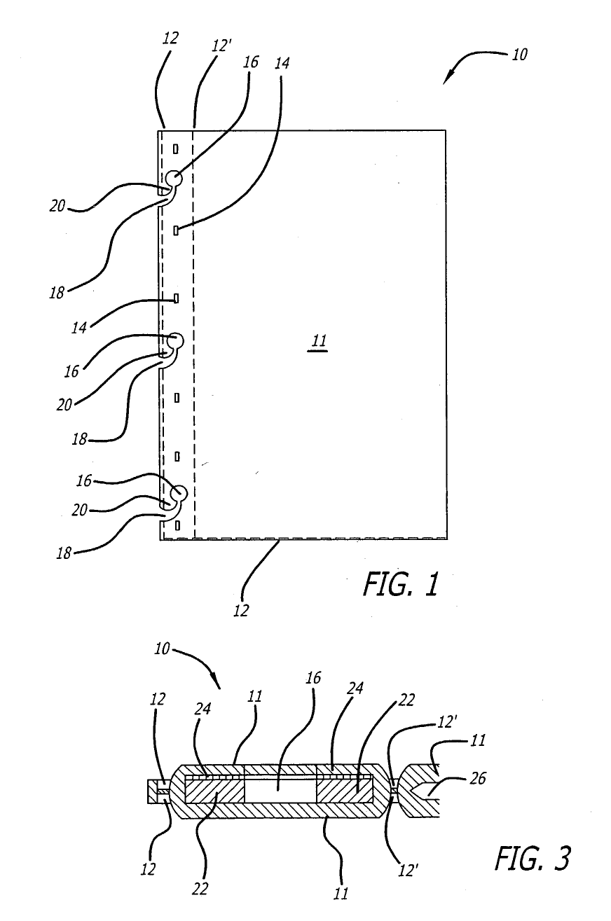

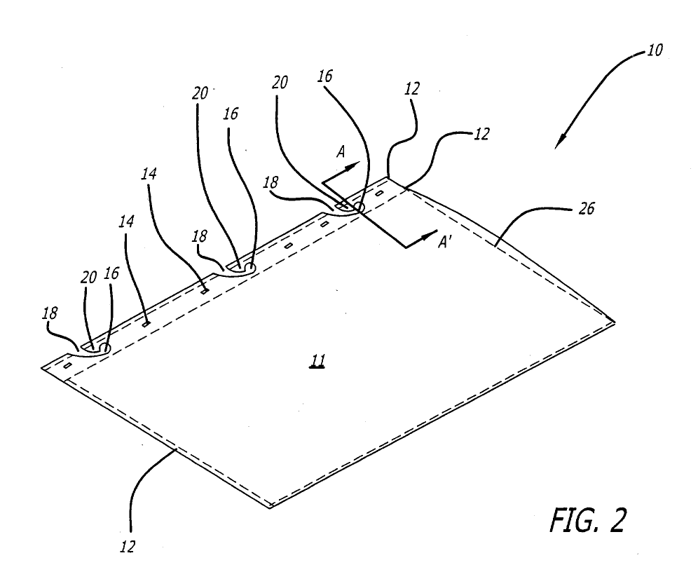

Referring more particularly to the figures, FIGS. 1 and 2 illustrate a first embodiment of the snap-in sheet protector 10 of the present invention. The snap-in sheet protector 10 may be made from at least one sheet 11 of material such as, but not limited to, polypropylene. The material is substantially clear so that the stored contents may be visible through the material. The sheet 11 is folded to form a pocket 26, and the edges of the sheet 11 may sealed together by any sealing means known by those skilled in the art, such as the use of a heated die.

As shown in FIGS. 1 and 2, a seam 12 is provided along the bottom edge and the left edge of the sheet 11 to form the pocket 26. Media such as, but not limited, to 8.5″×11″ sheets of paper, compact discs, diskettes, and business cards may be inserted into the pocket. Those skilled in the art will appreciate that the dimensions of the pocket may be altered depending on the media being stored.

FIGS. 1 and 2 also show that the left edge region includes holes 16 and channels 18. FIG. 1 shows three holes 16 provided on the snap-in sheet protector, but one, two, four or more holes may be provided on the snap-in sheet protector 10. The number of holes on the snap-in sheet protector may be adapted to correspond to the number of binder rings in the binder. Furthermore, the holes are adapted to receive a standard binder ring. However, those skilled in the art will appreciate that the size of the holes may be adapted for different binder applications.

The holes 16 are in communication with the left edge of the snap-in sheet protector 10 by channels 18. The channels 18 are curved structures to facilitate the insertion and removal of the snap-in sheet protector.

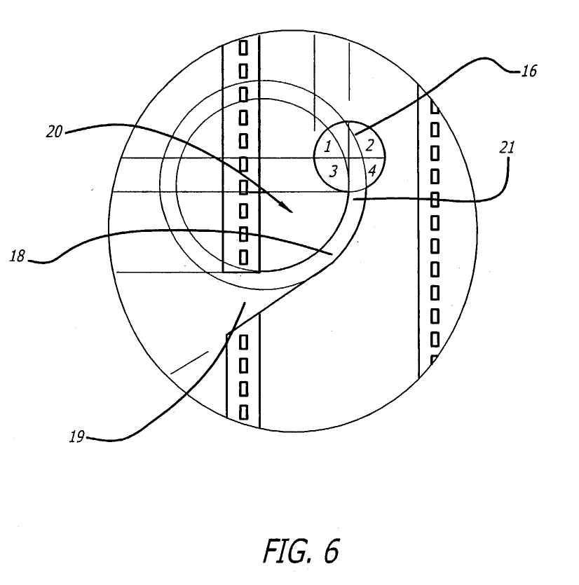

As shown in FIG. 1, the entry point 19 of the channel 18 is larger than the point at which the channel 18 joins the hole 16. The wider entry point 19 provides a better lead in opening to insert the snap-in sheet protector 10 into a binder. The tapered end 21 of the channel is designed so that the snap-in sheet protector is retained in the binder. Furthermore, the channel 18 joins the hole 16 in the fourth quadrant of the hole as shown in FIG. 6. By joining the channel 18 to the hole 16 at this juncture, the possibility that the snap-in sheet protector may be dislodged from the binder ring may be minimized. Furthermore, the snap-in sheet protector includes a larger hooking area 20 as compared to prior art snap-in protectors.

FIG. 3 illustrates a cross sectional end view of the snap-in sheet protector 10 along line A-A′. In particular, a stiffening member 22 is provided between the sheet material 11. The stiffening member may be made from a polyester material such as, but not limited to, Mylar®. The stiffening member 22 adds rigidity to the snap-in sheet protector 10. The additional rigidity provided by the stiffening member 22 allows the snap-in sheet protector to be inserted into a binder without opening the binder rings. The stiffening member 22 is held within the slot between the seams 12, 12′. That is, the stiffening member 22 is held in position by an interference fit between the seams 12, 12′.

Additionally, a heat-activated adhesive 24 may be applied to at least one surface of the stiffening member 22. In an alternative embodiment, the stiffening member may be provided with adhesives on both sides of the stiffening member. In yet another embodiment, the adhesive may be placed along the stiffening member at a spaced interval. The adhesive 24 locks the stiffening into a fixed position thereby eliminated the possibility that the stiffening member may move and become misaligned with the holes an channels of the sheet protector 10. Furthermore, individual tacking members 14 may optionally be placed along the snap-in sheet between the seams 12, 12′ to lock the stiffening member within the spaced defined between the seams 12,12′. The tacking members 14 are similar to the seams 12, 12′ that may be used to bind the sheet material 11 together.

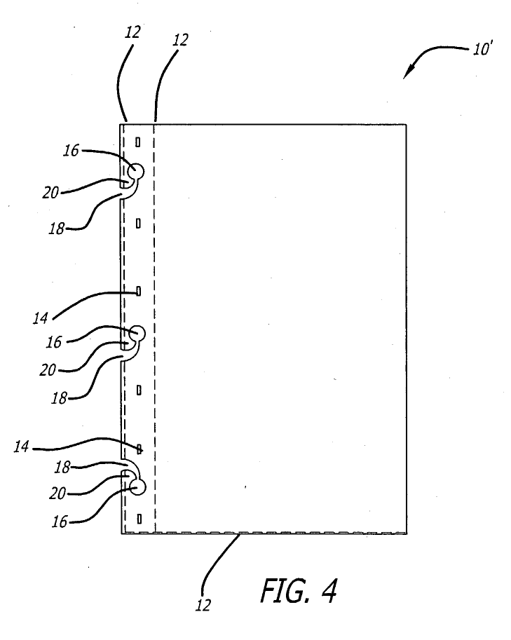

FIG. 4 illustrates an alternative embodiment of the snap-in sheet protector 10′ of the present invention. The snap-in protector 10′ is the similar to the snap-in sheet protector 10 of FIG. 1 with the exception of the orientation of the lowest channel 18. The lowest channel 18 is oriented in the opposite direction as compared to the middle and top channels. Those skilled in the art will appreciate that the channels 18 may be differently oriented in a plurality of directions.

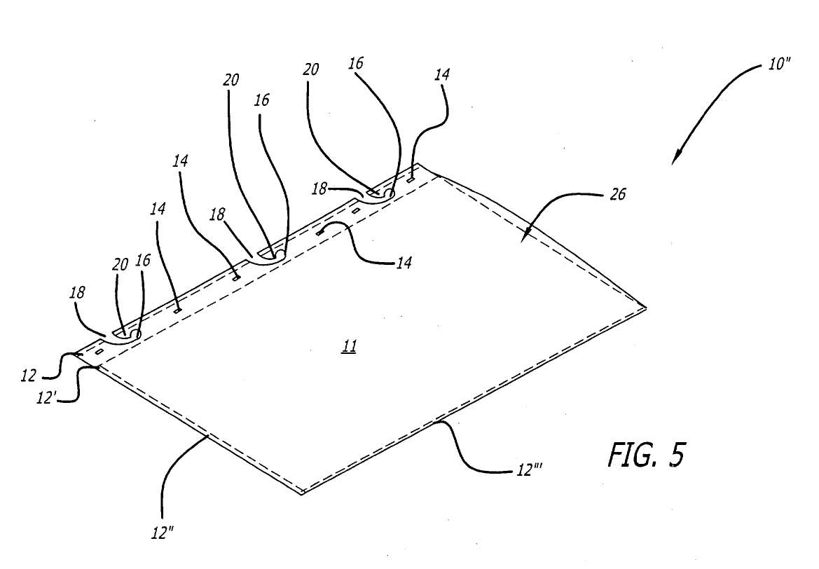

FIG. 5 illustrates yet another embodiment of a snap-in sheet protector 10″ that is made in accordance with the teachings of the present invention. The snap-in protector 10′ is similar to the snap-in sheet protector 10 of FIG. 1 with the exception that the snap-in sheet protector in the embodiment shown in FIG. 5 is made from two sheets of material. The first sheet of material is placed upon the second sheet of material. Seams 12, 12″, 12′″ are made along the left edge, bottom edge, and right edge of the sheets, respectively, to form a pocket 26.

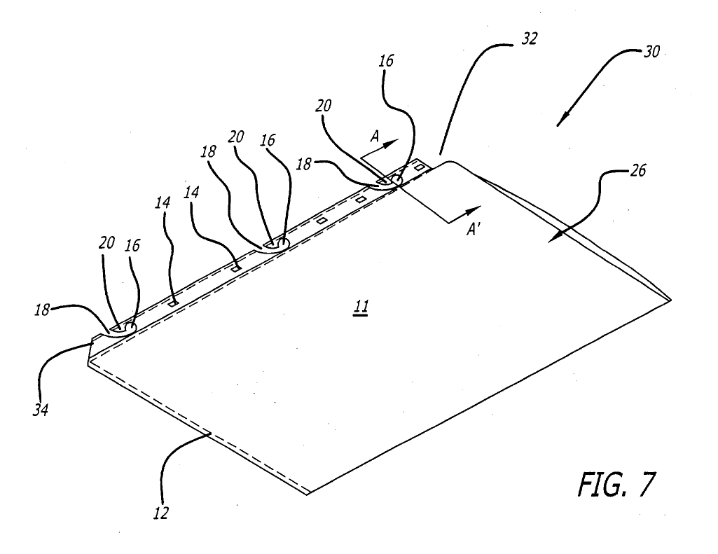

FIG. 7 illustrates yet another embodiment of a snap-in sheet protector 30 that is made in accordance with the teachings of the present invention. The snap-in protector 30 is similar to the snap-in sheet protector 10 of FIG. 1 with the exception that the snap-in sheet protector in the embodiment shown in FIG. 7 is includes corner cuts 32, 34. The corner-cuts 32, 34 may have a plurality of shapes and FIG. 7 illustrates two possible embodiments. The corner-cut 32 is an “L-shaped” cut that removes a rectangular-shaped portion from a corner of the snap-in sheet protector 30. The corner-cut 34 is a beveled cut that is approximately 45° angle. The corner-cut 34 removes a triangular-shaped portion of the snap-in sheet protector 30. The corner-cuts 32, 34 provide clearance from any lock-booster tabs that may be provided on the ringbinders. That is, snap-in sheet protectors 30 having the corner-cuts 32, 34 are able to move freely along the binder ring without brushing the lock-booster tabs. Furthermore, the cut-corners 32, 34 provide enough clearance to allow an individual user to operate the lock-booster tabs. The snap-in sheet protector 30, as shown in FIG. 7, is provided with two differently shaped corner-cuts 32, 34. Those skilled in the art will appreciate that alternate embodiments of the snap-in sheet protector where both corner-cuts are beveled or both corner-cuts are L-shaped.

The snap-in sheet protector 10″ of the present invention may be formed by the following process. The snap-in sheet protector 10″ may be formed by providing a first roll of material to define a first sheet and a second roll of material to define a second sheet of the snap-in sheet protector. A portion of the first roll and the second roll are unwound so that the first sheet overlaps the second sheet. A stiffening member 22 is inserted between the first sheet and the second sheet. The stiffening member 22 may be a Mylar® strip having a heat activated adhesive coated on at least one surface of the stiffening member 22. Seams along the left edge 12, bottom edge 12′, and right edge 12″ are formed on the sheets to form the pocket 26 of the snap-in sheet protector 10″. The application of heat to form the seal also activates the adhesive that is applied to the stiffening member 22. Accordingly, at a minimum, the stiffening member 22 is secured within the snap-in sheet protector by seams 12, 12′ and heat seal. The adhesive secures the stiffening member 22 to the sheets. Optionally, the stiffening member may be tacked to the sheets by spot welds 14. The holes 16 and the channel 18 are then punched from the sheet material to from the completed snap-in sheet protector 10″.

The snap-in sheet protector 10, 10′ may be made according to the following process. A roll of material that defines a first sheet of material is unwound. The sheet is then folded in half so that the right edge overlies the left edge. A stiffening member 22 is inserted between the right edge and the second edge. The stiffening member 22 may be a Mylar® strip having a heat activated adhesive coated on at least one surface of the stiffening member 22. Seams along the left edge 12 and bottom edge 12′ to form the pocket 26 of the snap-in sheet protector 10, 10′. The application of heat to form the seal also activates the adhesive that is applied to the stiffening member 22. The adhesive secures the stiffening member 22 to the sheets. Accordingly, at a minimum, the stiffening member 22 is secured within the snap-in sheet protector by seams 12, 12′ and heat seal. Optionally, the stiffening member may be tacked to the sheets by spot welds 14. The holes 16 and the channel 18 are then punched from the sheet material to from the completed snap-in sheet protector 10,10′.

Various modifications may be made to the embodiments. One of the many such modifications relates to the path of the curved channel. In one embodiment, the curved channel follows a portion of a circle. This path shape is attractive aesthetically. It also provides a smooth pathway for gradually slipping the sheet onto the rings of the binder. The path may alternatively “squiggle” as, for example, in an “S” shape or “snake” shape, in order make it particularly difficult for the sheet to become disengaged after it has been inserted into the binder.

The foregoing has presented a presently preferred embodiment of the present invention. However, a specific embodiment merely exemplifies the invention. The invention itself is not limited to the examples in the Detailed Description. Rather, the claims that follow define the metes and bounds of the invention.

What is claimed is:

1. A sheet protector comprising:
flexible sheet material joined together to form a pocket;
a plurality of holes placed adjacent to at least one edge of the sheet protector; and
a plurality of curved slits joining the holes to the edge of the sheet protector, wherein the curved slits are adapted for releasable engagement with rings of loose-leaf ring binders.

2. The sheet protector of claim 1 wherein at least one edge includes a stiffening member.

3. The sheet protector of claim 2 wherein the stiffening member is affixed to the sheet material by a heat activated adhesive.

4. The sheet protector of claim 3 wherein the stiffening member is further affixed to the sheet material by a spot weld.

5. The sheet protector of claim 1 wherein the pocket is adapted to hold an object selected from the group consisting of an 8.5″×11″ sheet, compact discs, diskettes, and business cards.

6. The sheet protector of claim 1 wherein the curved slits are tapered.

7. A sheet protector comprising:
a pocket made from at least one sheet of material;
a stiffening member permanently attached to at least one edge of the sheet protector;
a plurality of holes placed adjacent to at least one edge of the sheet protector; and
a plurality of curved slits joining the holes to the edge of the sheet protector, wherein the curved slits are adapted for releasable engagement with loose-leaf ring binders.

8. The sheet protector of claim 7 wherein the pocket is adapted to hold an object selected from the group consisting of a 8.5″×11″ sheet, compact discs, diskettes, and business cards.

9. The sheet protector of claim 7 wherein the stiffening member is affixed to the sheet material by a heat activated adhesive.

10. The sheet protector of claim 9 wherein the stiffening member is further affixed to the sheet material by a spot weld.

11. The sheet protector of claim 7 wherein the curved slits are tapered.

12. A sheet protector comprising:
at least one sheet of material adapted to form a pocket by providing a seam along the left edge and the bottom edge of the sheet of material;
a stiffening member having an adhesive applied to at least one surface of the stiffening member,
the stiffening member located along the left edge of the pocket, wherein the stiffening member is secured to the left edge by at least one seam;
a plurality of holes placed adjacent to at least one edge of the sheet protector; and
a plurality of curved slits joining the holes to the left edge of the sheet protector, wherein the curved slits are tapered from the left edge of the sheet protector to the holes, and the curved slits are adapted for releasable engagement with loose-leaf ring binders.

13. The sheet protector of claim 12 further including a seam long the right edge of the pocket.

14. The sheet protector of claim 12 wherein the stiffening member is further affixed to the sheet material by a spot weld.

15. The sheet protector of claim 12 wherein the pocket is adapted to hold an object selected from the group consisting of a plurality of 8.5″×11″ sheets of paper, compact discs, diskettes, and business cards.

16. A method of inserting a sheet protector into a binder, the method comprising the steps of:
providing a sheet protector as defined in claim 1;
aligning at least one channel of said sheet protector with a ring in the binder;
sliding the sheet protector relative to the ring, with the ring engaged in the curved channel of the sheet protector, to secure the sheet protector on the ring;
wherein the at least one channel has an opening at an edge of the sheet protector and another opening at a hole that is offset from the edge of the sheet protector, the opening at the edge being wider than the opening at the hole.
